(19) United States
(12) Patent Application Publication
(10) Pub. No.: US 2024/0391526 A1
(43) Pub. Date: Nov. 28, 2024

(54) Inertial Motion Unit Based Total Machine Turning Angle

(71) Applicant: Caterpillar Inc., Peoria, IL (US)

(72) Inventors: Ethan M. Tevis, Bloomington, IL (US); Michael C. Gentle, Maroa, IL (US); Timothy A. Evans, Washington, IL (US)

(73) Assignee: Caterpillar Inc., Peoria, IL (US)

(21) Appl. No.: 18/322,925

(22) Filed: May 24, 2023

(51) Int. Cl. B62D 12/00; B62D 15/02

(52) U.S. Cl. CPC B62D 12/00; B62D 15/024; E02F 3/841

(57) ABSTRACT

A system for determining a total machine turning angle of a construction equipment having a front frame articulatable with respect to a rear frame, the front frame including a steering apparatus and the rear frame including a traction device, the construction equipment having a wheelbase, the system including: a first inertial motion unit disposed on the front frame or the rear frame, the first inertial motion unit providing a front frame yaw rate if disposed on the front frame or a rear frame yaw rate if disposed on the rear frame; a machine speed sensor providing a machine speed of the construction equipment; and a controller for receiving as inputs the wheelbase, machine speed, and either the front frame yaw rate or the rear frame yaw rate, and outputting the total machine turning angle based on the wheelbase, the machine speed, and either the front or rear frame yaw rate.

### FIELD

The present disclosure generally relates to construction equipment, such as a motor grader, and more particularly to systems, methods, and controllers for determining a total machine turning angle of a motor grader.

### BACKGROUND

A motor grader is a versatile apparatus for road work, ditch work, site preparation and other surface contouring and finishing tasks. The versatility of a motor grader is provided in large part by its multiple course-setting and course-change options. In particular, a motor grader typically includes a steering function implemented via steerable ground-engaging wheels while also allowing some degree of course correction or steering via lateral arching or articulation of the machine frame. In a conventional motor grader, a total machine turning angle of the motor grader is used in connection with operation of the motor grader. But due to the steering function of the front wheels and the articulation of the machine frame, determining the total machine turning angle of the motor grader can be a complex task.

FIGS. 1-2 are a schematic views of a conventional motor grader 10, which will be discussed in more detail to explain what is typically involved in determining the total machine turning angle. As shown, motor grader 10 includes a front frame 12, rear frame 14, and a work implement 16. e.g., a blade assembly 18. Rear frame 14 includes a power source, contained within a rear compartment 20, that is operatively coupled through a transmission to rear traction devices or wheels 22 for primary machine propulsion.

Rear wheels 22 are operatively supported on tandem axles 24, which are pivotally connected to motor grader 10 between rear wheels 22 on each side of motor grader 10. The power source may be, for example, a diesel engine, a gasoline engine, a natural gas engine, or any other engine. The power source may also be an electric motor linked to a fuel cell, capacitive storage device, battery, or another source of power. The transmission may be a mechanical transmission, hydraulic transmission, or any other transmission type. The transmission may be operable to produce multiple output speed ratios (or a continuously variable speed ratio) between the power source and driven traction devices.

Front frame 12 typically supports an operator station 26 that contains operator controls, along with a variety of displays or indicators for conveying information to the operator for primary operation of motor grader 10. Front frame 12 may also include a beam 28 that supports blade assembly 18 and is employed to move blade 30 to a wide range of positions relative to motor grader 10.

Motor grader steering is accomplished through a combination of both front wheel steering and machine articulation (i.e., an articulation of front frame 12 with respect to rear frame 14). As shown in FIG. 2, steerable traction devices, such as right and left wheels 58, 60, are associated with beam 28. Wheels 58, 60 may be both rotatable and tiltable for use during steering and leveling of a work surface 86. Front wheels 58, 60 are connected via a steering apparatus 88 that may include a linkage 90 and a hydraulic cylinder for rotation about front wheel pivot points 80 (e.g., as shown in FIG. 3), and tilt cylinders 92 for front wheel tilt. Front steerable wheels 58, 60 and/or rear driven traction devices 22 may include tracks, belts, or other traction devices as an alternative to wheels. Front wheels 58, 60 may also be driven, as is the case in motor graders provided with all-wheel drive. For example, the power source may be operatively connected to a hydraulic pump fluidly coupled to one or more hydraulic motors associated with front wheels 58, 60.

Referring to FIGS. 1 and 3, motor grader 10 includes an articulation joint 62 that pivotally connects front frame 12 and rear frame 14. Both a right articulation actuator 64 and left articulation actuator 66 are connected between front frame 12 and rear frame 14 on opposing sides of motor grader 10. Right and left articulation actuators 64, 66 are used to pivot front frame 12 relative to rear frame 14 about an articulation axis B. In FIG. 2, motor grader 10 is positioned in the neutral or zero articulation angle α position wherein a longitudinal axis 48 of front frame 12 is aligned with a longitudinal axis 68 of rear frame 14.

FIG. 3 is a schematic top view of motor grader 10 with front frame 12 rotated at an articulation angle +α defined by the intersection of longitudinal axis 48 of front frame 12 and longitudinal axis 68 of the rear frame 14, the intersection corresponding with the position of articulation joint 62. In this illustration, a positive articulation angle α is indicative of a left articulation from the perspective of a motor grader operator facing forward, while a negative articulation angle α would be indicative of a right articulation. A front wheel turning angle θ_{FW} is defined between a longitudinal axis 76 parallel to longitudinal axis 48 of front frame 12 and a longitudinal axis 78 of front wheels 58, 60, the front wheel turning angle θ_{FW} having an origin at pivot point 80 of front wheels 58, 60. This is demonstrated in connection with left front wheel 60, but applies equally to right front wheel 58. Front wheel turning angle θ_{FW} may be based upon either a turning angle for right front wheel 58 or left front wheel 60. However, a centerline turning angle may be calculated that is an average of right and left turning angles in the event that some variation or error exists based upon, for example, wheel misalignment or sensor errors.

The tandem arrangement of rear tires 22 behaves equivalently to a machine including a single wheel on each side of the machine, the hypothetical wheel being disposed at the center of each tandem 24. Thus, a rear centerline point 82 disposed equidistant from a midpoint of the two opposing tandems 24 will track a front centerline point 84 between pivot points 80 of front wheels 58, 60. That is, front centerline point 84 is a midpoint of a line connecting pivot points 80 of right and left front wheels 58, 60.

FIG. 4 shows a block diagram of a steering control system 100 for motor grader 10. Control system 100 generally includes a controller 102 configured, for example, via a control algorithm, to receive a plurality of instructions from various sensors and/or operator commands, and to responsively provide instructions to control various machine actuators and/or communicate with the machine operator. Controller 102 may include various components for executing software instructions designed to regulate various subsystems of motor grader 10. For example, controller 102 may include a central processing unit (CPU), a random access memory (RAM), a read-only memory (ROM), input/output elements, etc. Controller 102 may execute machine readable instructions stored in controller 102 on a mass storage device, RAM. ROM, local memory, and/or on a removable storage medium, such as a CD, DVD, and/or flash memory device.

Control system 100 controls articulation of motor grader 10 based upon operator control of the front wheel steering of motor grader 10. Accordingly, controller 102 receives an indication of front wheel turning angle θ_{FW}. Motor grader 10 may include one or more steering sensors 104 associated with one or both of right and left front wheels 58, 60. Steering sensors 104 monitor front wheel turning angle θ_{FW} by monitoring angles of rotation of steering linkages 90 and/or pivot points 80 at front wheels 58, 60.

Steering sensors 104 monitor front wheel turning angle θ_{FW} by measuring an extension amount of an actuator, such as a hydraulic actuator, that controls the steering of front wheels 58, 60. Steering sensors 104 may provide data “indicative of” the turning angle, including direct measurements of the quantity or characteristic of interest, as well as indirect measurements, such as a different quantity or characteristic having known relationships with the quantity or characteristic of interest.

Controller 102 receives a signal from one or more operator steering controls 106 employed to provide an indication of front wheel turning angle θ_{FW}. These steering controls 106 may be, for example, a steering wheel 106 as shown in FIGS. 1-2, or any other type of operator input device, such as a dial, joystick, keyboard, pedal, or other devices. For example, a steering wheel sensor may be provided that senses a rotation or position of steering wheel 106 to provide an indication of front wheel turning angle θ_{F}w.

One or more articulation sensors 108 may provide an indication of the articulation angle α at axis B between rear frame 14 and front frame 12. Articulation sensor 108 is typically a pivot sensor disposed at articulation joint 62 to sense rotation at articulation axis B. Articulation sensor 108 may monitor the extension of right and/or left articulation actuators 64, 66. Steering sensors 104 and articulation sensors 108 could be any type of sensor, including, for example, potentiometers, extension sensors, proximity sensors, angle sensors, and the like.

Other inputs that may be associated with control system 100 may include machine speed sensors 112, which could be any sensor configured to monitor machine travel speed or linear velocity, including sensors associated with any of the front wheels, rear wheels, axle shafts, motors, or other components of the drivetrain of motor grader 10.

During standard machine operations, the operator may manually operate both steering controls 106 and articulation controls 116 to maneuver motor grader 10. Operator steering control instructions may be provided indirectly through controller 102 that responsively provides steering control instructions 118 to control steering apparatus 88. Similarly, operator articulation controls 116 may provide articulation instructions to controller 102 that responsively provides articulation control instructions 122 to control articulation actuators 64, 66. Such control instructions may be, for example, pilot or electro-hydraulic signals that control operation of one or more pumps, motors, or valves of a hydraulic system that operates steering apparatus 88 and/or articulation actuators 64, 66.

In conventional motor grader 10, both articulation angle α and front wheel turning angle θFW are used to determine the total machine turning angle. However, in addition to the complexity of such a system and the difficulty associated with determining front wheel turning angle θFW, as described above, steering sensors such as steering sensors 104 are also costly. There is therefore a need for more practical solutions for determining the total machine turning angle of an articulatable piece of construction equipment, such as a motor grader.

### SUMMARY

One aspect of the present disclosure is directed to a system for determining a total machine turning angle of a construction equipment having a front frame articulatable with respect to a rear frame, the front frame including a steering apparatus and the rear frame including a traction device, the construction equipment having a wheelbase, the system comprising: a first inertial motion unit disposed on the front frame or the rear frame, the first inertial motion unit being configured to provide a front frame yaw rate if disposed on the front frame or a rear frame yaw rate if disposed on the rear frame; a machine speed sensor configured to provide a machine speed of the construction equipment; and a controller configured to receive as inputs the wheelbase, machine speed, and either the front frame yaw rate or the rear frame yaw rate, and output the total machine turning angle based on the wheelbase, the machine speed, and either the front frame yaw rate or the rear frame yaw rate.

Another aspect of the present disclosure is directed to a method for determining a total machine turning angle of a construction equipment having a front frame articulatable with respect to a rear frame, the front frame including a steering apparatus and the rear frame including a traction device, the construction equipment having a wheelbase, the method comprising: receiving a rear frame yaw rate or a front frame yaw rate from a first inertial motion unit disposed on the rear frame or the front frame, respectively; receiving a machine speed of the construction equipment; receiving the wheelbase as an input; and outputting the total machine turning angle based on the wheelbase, the machine speed, and either the rear frame yaw rate or the front frame yaw rate.

A further aspect of the present disclosure is directed to a controller for determining a total machine turning angle of a construction equipment having a front frame articulatable with respect to a rear frame, the front frame including a steering apparatus and the rear frame including a traction device, the construction equipment having a wheelbase, the controller being configured to: receive as input a rear frame yaw rate or a front frame yaw rate from a first inertial motion unit disposed on the rear frame or the front frame, respectively; receive a machine speed of the construction equipment; receive the wheelbase as an input; and output the total machine turning angle based on the wheelbase, the machine speed, and either the rear frame yaw rate or the front frame yaw rate.

### BRIEF DESCRIPTION OF THE DRAWINGS

FIG. 1 is a side view of a conventional motor grader;

FIG. 2 is a top view of the motor grader of FIG. 1:

FIG. 3 is a schematic top view of the motor grader of FIGS. 1-2 showing articulation of a front frame of the motor grader with respect to a rear frame of the motor grader;

FIG. 4 shows a conventional steering control system for the motor grader of FIGS. 1-3:

FIG. 5 shows a motor grader according to the present disclosure; and

FIG. 6 shows a steering control system for a motor grader according to the present disclosure.

### DETAILED DESCRIPTION

The present application describes systems, methods, and controllers for determining a total machine turning angle θ_{M} of a motor grader, such as conventional motor grader 10. Rather than use conventional steering sensors, such as such as steering sensors 104, to determine front wheel turning angle θ_{FW}, the present application describes using one or more inertial motion units, or IMUs, to determine total machine turning angle θ_{M}.

An IMU is a measuring device that may include a number of sensors. The sensors may include accelerometers and/or gyroscopes. The sensors may generate signals indicative of various positional attributes of the object to which it is attached, such as a change in the velocity of object, a change in the attitude/orientation of the object, and a change in the path of travel of the object. The IMU determines the acceleration of the object based on the signals generated by the sensors of the IMU.

In some instances, the IMU also determines changes in rotational attributes of the object, such as, pitch, roll, and yaw. In the context of a motor grader, the pitch describes rotation about an axis running from the left of the motor grader to the right of the motor grader, roll describes rotation about an axis running from the front of the motor grader to the rear of the motor grader (i.e., an axis extending between front frame 12 to rear frame 14), and yaw describes rotation about an axis that runs vertically through the motor grader, similar to articulation axis B. The yaw rate, in turn, is the rate of change of the yaw over time, and provides an indication of how quickly the component of the motor grader to which the IMU is attached is turning (e.g., to the left or to the right from the perspective of the motor grader). The IMU may include any other means to assist in determination of the location of the motor grader.

The present application also describes the use of a global navigation satellite system, or GNSS, in conjunction with the systems, methods, and controllers herein. A GNSS is a satellite navigation system with global coverage that can be used to provide autonomous geo-positioning of objects associated with the GNSS, such as an autonomously operated motor grader. One example of a GNSS is a global positioning system, or GPS. The GNSS may include a satellite positioning unit disposed on the motor grader. The satellite positioning unit generates signals indicative of the location of the motor grader (e.g., on a work surface at a worksite). The satellite positioning unit may determine and generate signals corresponding to the latitude and/or longitude of the motor grader. The satellite positioning unit may be disposed on a top portion of the motor grader to communicate with a number of satellites of the GNSS and to receive signals indicative of the location of the motor grader. In the context of IMUs specifically, the GNSS and its satellite positioning unit can be used to correct any bias in the output provided by the IMUs in order to obtain more accurate readings and therefore enable more precise control of the motor grader.

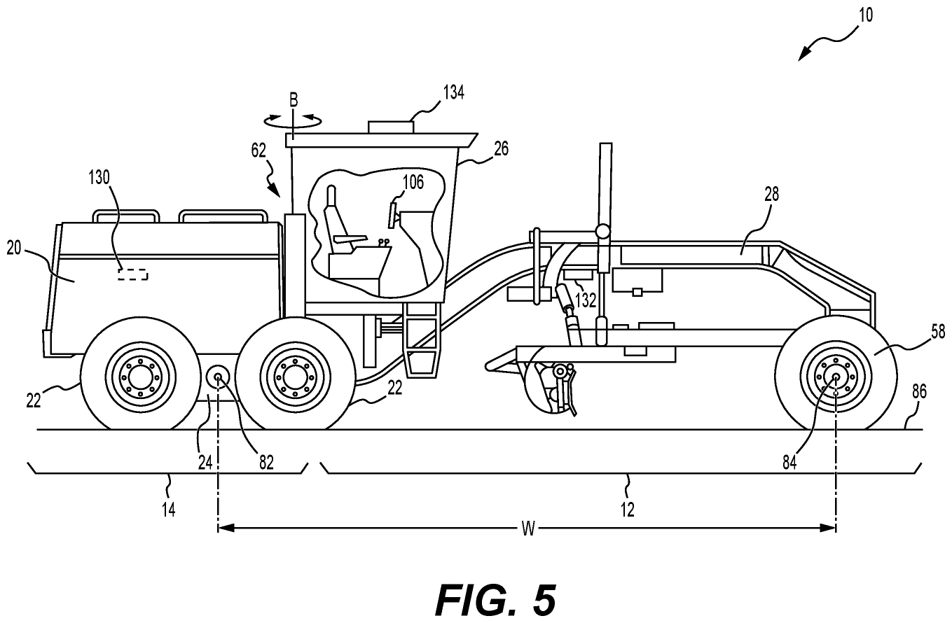

The systems, methods, and controllers of the present application also take into consideration the wheelbase of the motor grader, which can be fixed or variable. In general, the wheelbase of a vehicle is the distance between its front wheels and its rear wheels, or more specifically its front axle and its rear axle. In the context of a motor grader, which often has rear wheels that are operatively supported on tandem axles, the tandem arrangement of rear tires behaves equivalently to a machine including a single wheel on each side of the machine, the hypothetical wheel being disposed at the center of each tandem, as discussed above. Thus, rear centerline point 82 (as shown in FIG. 5) is disposed equidistant from a midpoint of the two opposing tandems 24. In the sense of a fixed wheelbase then, wheelbase W is equivalent to a distance between rear centerline point 82 and front centerline point 84, which is the midpoint of a line connecting pivot points 80 of right and left front wheels 58, 60. Given that front frame 12 of a motor grader articulates with respect to rear frame 14, however, the wheelbase can also be treated as variable. In particular, wheelbase W would be a function of articulation angle α rather than a constant. The present application contemplates that wheelbase W could be treated either as a constant or as a variable.

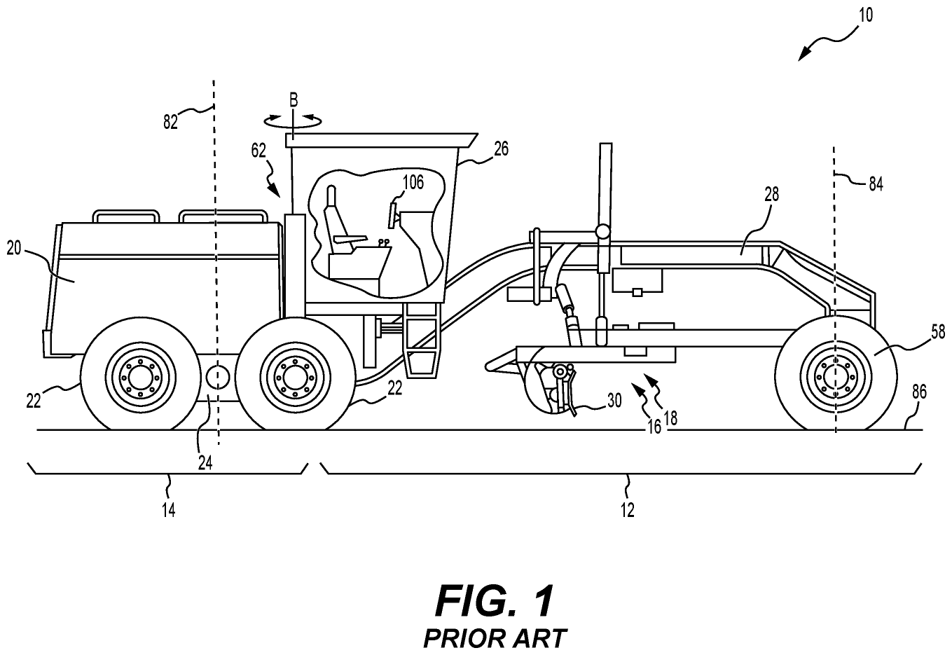

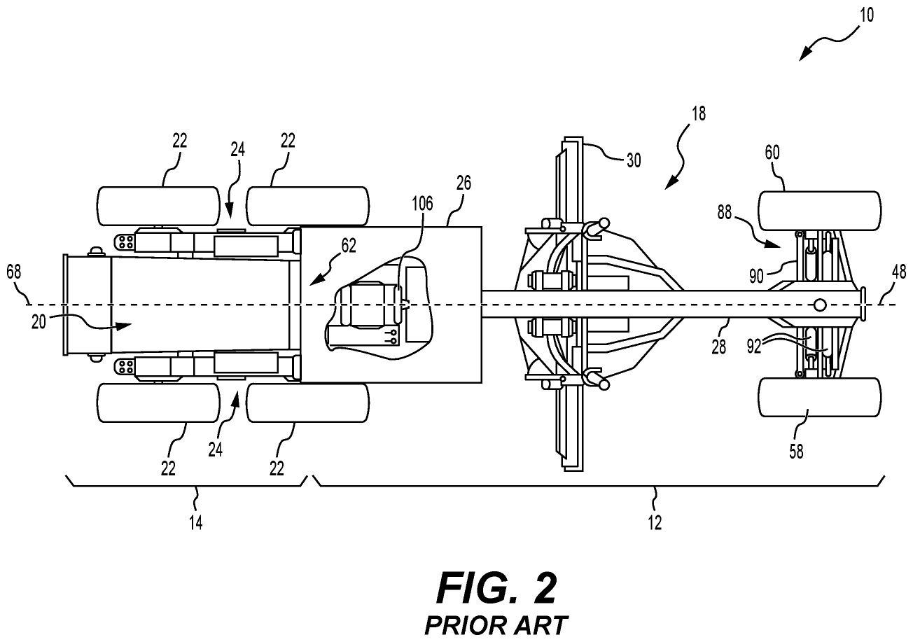

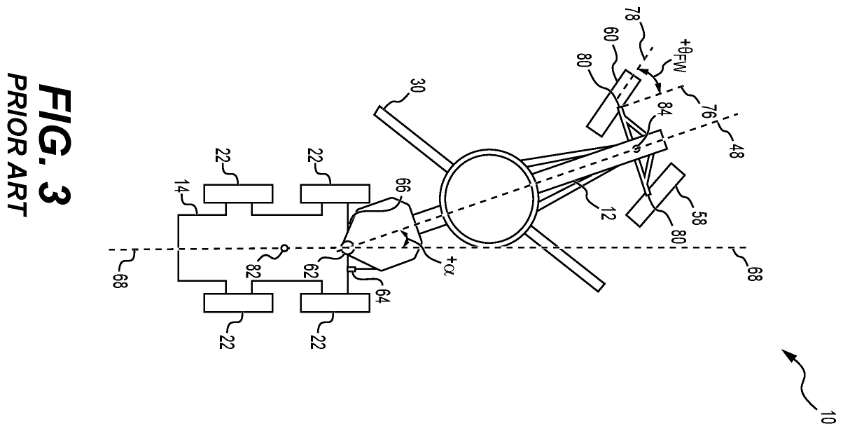

FIG. 5 shows a motor grader 10 that is identical to conventional motor grader 10 shown in FIGS. 1-3, but has a number of additional components, including first IMU 130 mounted to rear frame 14 of motor grader 10 (e.g., in rear compartment 20), second IMU 132 mounted to front frame 12 of motor grader 10 (e.g., on beam 28), and satellite positioning unit 134, which is a component of the GNSS with which motor grader 10 is associated. Although satellite positioning unit 134 is shown as being disposed on operator station 26, which improves reception, satellite positioning unit 134 may be disposed elsewhere on motor grader 10. First IMU 130 and second IMU 132 may also be disposed elsewhere on rear frame 14 and front frame 12, respectively, including first IMU 130 being disposed on front frame 12 and second IMU 132 being disposed on rear frame 14. However, given the articulation of front frame 12 with respect to rear frame 14 about articulation joint 62, it is preferable to have one IMU disposed on front frame 12 another IMU disposed on rear frame 14.

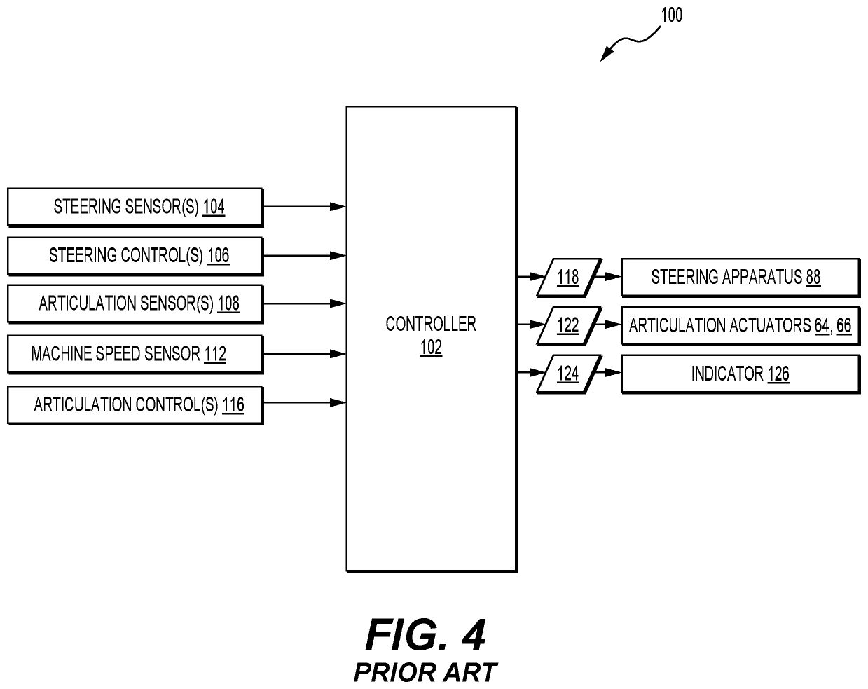

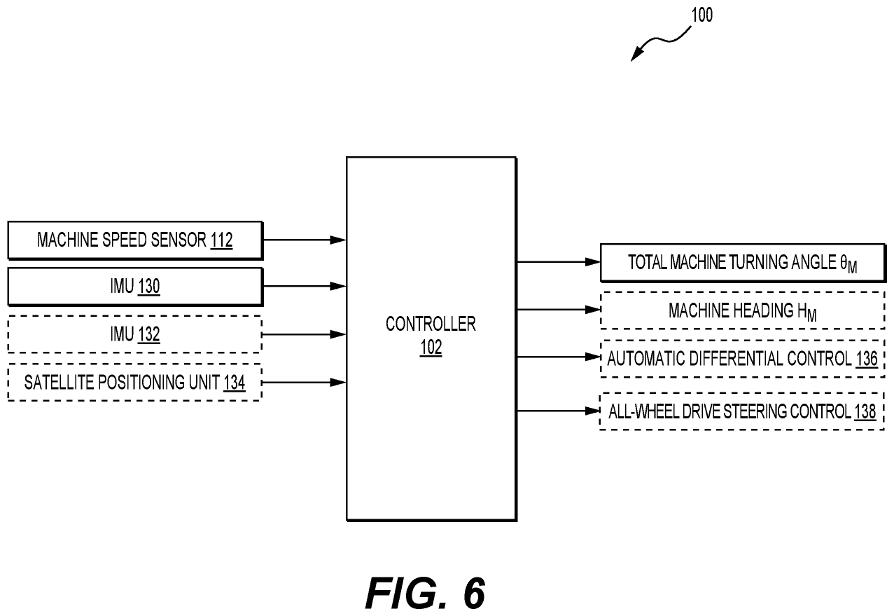

FIG. 6 shows a controller 102 that is similar to that described in the context of FIG. 4, but incorporates a number of different inputs and produces a number of different outputs. Specifically, first IMU 130, which may be disposed, for example, on rear frame 14 of motor grader 10, provides controller 102 with a number of inputs associated with rear frame 14. Those inputs could include positional, acceleration, and rotational attributes of rear frame 14. As one example, first IMU 130 can provide controller 102 with the yaw rate of rear frame 14, ΔY_{RF}, if first IMU 130 is mounted to rear frame 14. Second IMU 132, which may be disposed on front frame 12 of motor grader 10, provides the same inputs to controller 102 but with respect to front frame 12 rather than rear frame 14. For example, second IMU 132 can provide controller 102 with the yaw rate of front frame 12, ΔY_{FF}, if second IMU 132 is mounted to front frame 12. Alternatively, first IMU 130 could be mounted to front frame 12 and second IMU 132 could be mounted to rear frame 14, each IMU providing outputs associated with the specific frame part to which they are attached.

As discussed with respect to FIG. 4, machine speed sensor 112 could be any sensor configured to monitor machine speed or linear velocity, V, including a sensor associated with any of the front wheels, rear wheels, axle shafts, motors, or other components of the drivetrain of motor grader 10.

Once controller 102 receives inputs from machine speed sensor 112 and first IMU 130, controller 102 can calculate total machine turning angle θ_{M}. Total machine turning angle θ_{M} can be calculated according to the following equation:

$${θ}_{M} = arc tan ( V / ( Δ {Y}_{RF} * W ) ,$$

where V equals the machine speed of motor grader 10. ΔY_{RF} equals the yaw rate of rear frame 14, and W equals the wheelbase of motor grader 10 (i.e., the distance between rear centerline point 82 and front centerline point 84), which can be fixed or variable.

Alternatively, total machine turning angle θ_{M} could instead be based on the yaw rate of front frame 12, ΔY_{RF}, if first IMU 130 is disposed on front frame 12. In such an arrangement, total machine turning angle θ_{M} can be calculated according to the following equation:

$${θ}_{M} = arc tan ( V / ( Δ {Y}_{FF} * W ) ,$$

where V equals the machine speed of motor grader 10. ΔY_{FF} equals the yaw rate of front frame 12, and W equals the wheelbase of motor grader 10 (i.e., the distance between rear centerline point 82 and front centerline point 84), which can be fixed or variable.

Satellite positioning unit 134 can also provide inputs to controller 102. In particular, inputs from satellite positioning unit 134 can be used to correct bias that may be inherent in the outputs of controller 102, including total machine turning angle θ_{M}. Inputs from satellite positioning unit 134 can also allow controller 102 to, in conjunction with inputs from first IMU 130 and/or second IMU 132, output a machine heading H_{M} of motor grader 10.

When motor grader 10 is equipped with both first IMU 130 and second IMU 132, each disposed to either side of articulation joint 62, a comparison of outputs of first IMU 130 and second IMU 132 (e.g., by controller 102) can also be used to determine articulation angle α. In this case, articulation sensor(s) 108 can be eliminated from motor grader 10.

Outputs of controller 102, including total machine turning angle θ_{M}, can be used in various applications with respect to motor grader 10. For example, total machine turning angle θ_{M} can be used in the context of automatic differential control 136 with respect to rear traction devices or wheels 22. In particular, motor graders commonly include a differential assembly that assists turning operations. The differential assembly is required to be locked and unlocked based on operational conditions of the motor grader. For example, the differential assembly may be locked during operation of the motor grader on a straight path, but unlocked while the motor grader turns on a curved path. Therefore, the motor grader is equipped with a differential lock that selectively locks and unlocks the differential assembly while the motor grader is in operation. The automatic differential control automatically activates and deactivates the differential lock based on a plurality of operational parameters (turning angle, engine torque, and/or transmission gear range). In this context, total machine turning angle θ_{M} could be used as one parameter to dictate when the automatic differential control 136 activates or deactivates. Automatic differential control is discussed in more detail in the context of U.S. Patent Application Publication 2015/0149054, for example.

Other applications of total machine turning angle θ_{M} are also possible. For example, total machine turning angle θ_{M} can be used in the drive control of right and left front wheels 58, 60, such as for all-wheel drive steering control 138 (which is discussed in U.S. Pat. No. 9,702,458), in anti-lock braking applications, to determine failure or detect faults of sensors used in motor grader 10, and for three-dimensional grade control features such as automatic blade controls, among others.

### INDUSTRIAL APPLICABILITY

In general, the systems, methods, and controllers of the present application are applicable for use in determining a total machine turning angle of a motor grader, which has a front frame that is articulatable to a rear frame. While solutions exist for determining this angle, the present application describes the use of one or more inertial motion units as a substitute for one or more steering sensors that determine a front wheel turning angle. The one or more inertial units determine yaw rates associated with the rear frame and/or the front frame as a means for determining the total machine turning angle. Using inertial motion units in place of steering sensors is a more cost-efficient and less complex way to determine the total machine turning angle.

Once the total machine turning angle is determined, the value can be used as an input in one or more applications associated with the motor grader, such as automatic differential control, all-wheel drive steering control, anti-lock braking applications, determining failure or detecting faults of sensors used in the motor grader, and three-dimensional grade control features, etc.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A. B or C” should be interpreted as including any singular entity from the listed elements, e.g., A, any subset from the listed elements, e.g., A and B. or the entire list of elements A. B and C.

The present disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A system for determining a total machine turning angle of a construction equipment having a front frame articulatable with respect to a rear frame, the front frame including a steering apparatus and the rear frame including a traction device, the construction equipment having a wheelbase, the system comprising:
a first inertial motion unit disposed on the front frame or the rear frame, the first inertial motion unit being configured to provide a front frame yaw rate if disposed on the front frame or a rear frame yaw rate if disposed on the rear frame;
a machine speed sensor configured to provide a machine speed of the construction equipment; and
a controller configured to receive as inputs the wheelbase, the machine speed, and either the front frame yaw rate or the rear frame yaw rate, and output the total machine turning angle based on the wheelbase, the machine speed, and either the front frame yaw rate or the rear frame yaw rate.

2. The system of claim 1, wherein the wheelbase is a constant value equal to a distance between a front centerline point of the steering apparatus and a rear centerline point of the traction device.

3. The system of claim 1, wherein the wheelbase is a variable value.

4. The system of claim 3, further comprising:
an articulation sensor configured to determine an articulation angle between the front frame and the rear frame,
wherein the variable value of the wheelbase is a function of the articulation angle.

5. The system of claim 1, further comprising:
a satellite positioning unit of a global navigation satellite system,
wherein the controller is configured to receive an output of the satellite positioning unit in order to correct a bias in the total machine turning angle.

6. The system of claim 1, wherein the total machine turning angle is calculated according to:
$${θ}_{M} = arc tan ( V / ( Δ {Y}_{RF} * W ) ,$$
where θ_{M} equals the total machine turning angle, V equals the machine speed, ΔY_{RF} equals the rear frame yaw rate, and W equals the wheelbase, if the first inertial motion unit is disposed on the rear frame, or
$${θ}_{M} = arc tan ( V / ( Δ {Y}_{FF} * W ) ,$$
where θ_{M} equals the total machine turning angle, V equals the machine speed, ΔY_{FF} equals the front frame yaw rate, and W equals the wheelbase, if the first inertial motion unit is disposed on the front frame.

7. The system of claim 1, further comprising:
a second inertial motion unit disposed on the front frame if the first inertial motion unit is disposed on the rear frame, or on the rear frame if the first inertial motion unit is disposed on the front frame.

8. The system of claim 7, wherein the controller is configured to determine an articulation angle between the front frame and the rear frame by comparing at least one output of the first inertial motion unit with at least one output of the second inertial motion unit.

9. A method for determining a total machine turning angle of a construction equipment having a front frame articulatable with respect to a rear frame, the front frame including a steering apparatus and the rear frame including a traction device, the construction equipment having a wheelbase, the method comprising:
receiving a rear frame yaw rate or a front frame yaw rate from a first inertial motion unit disposed on the rear frame or the front frame, respectively;
receiving a machine speed of the construction equipment;
receiving the wheelbase as an input; and
outputting the total machine turning angle based on the wheelbase, the machine speed, and either the rear frame yaw rate or the front frame yaw rate.

10. The method of claim 9, wherein the wheelbase is a constant value equal to a distance between a front centerline point of the steering apparatus and a rear centerline point of the traction device.

11. The method of claim 9, wherein the wheelbase is a variable value.

12. The method of claim 11, further comprising:
receiving an articulation angle between the front frame and the rear frame,
wherein the variable value of the wheelbase is a function of the articulation angle.

13. The method of claim 9, wherein the total machine turning angle is calculated according to:
$${θ}_{M} = arc tan ( V / ( Δ {Y}_{RF} * W ) ,$$
where θ_{M} equals the total machine turning angle, V equals the machine speed, ΔY_{RF} equals the rear frame yaw rate, and W equals the wheelbase, if the first inertial motion unit is disposed on the rear frame, or
$${θ}_{M} = arc tan ( V / ( Δ {Y}_{RF} * W ) ,$$
where θ_{M} equals the total machine turning angle, V equals the machine speed, ΔY_{FF} equals the front frame yaw rate, and W equals the wheelbase, if the first inertial motion unit is disposed on the front frame.

14. The method of claim 9, further comprising:
receiving the front frame yaw rate from a second a second inertial motion unit disposed on the front frame if the first inertial motion unit is disposed on the rear frame, or
receiving the rear frame yaw rate from a second a second inertial motion unit disposed on the rear frame if the first inertial motion unit is disposed on the front frame.

15. The method of claim 14, further comprising:
determining an articulation angle between the front frame and the rear frame by comparing at least one output of the first inertial motion unit with at least one output of the second inertial motion unit.

16. A controller for determining a total machine turning angle of a construction equipment having a front frame articulatable with respect to a rear frame, the front frame including a steering apparatus and the rear frame including a traction device, the construction equipment having a wheelbase, the controller being configured to:
receive as input a rear frame yaw rate or a front frame yaw rate from a first inertial motion unit disposed on the rear frame or the front frame, respectively;
receive a machine speed of the construction equipment;
receive the wheelbase as an input; and
output the total machine turning angle based on the wheelbase, the machine speed, and either the rear frame yaw rate or the front frame yaw rate.

17. The controller of claim 16, wherein the wheelbase is a constant value equal to a distance between a front centerline point of the steering apparatus and a rear centerline point of the traction device.

18. The controller of claim 16, wherein the wheelbase is a variable value.

19. The controller of claim 18, wherein the controller is configured to:
receive an articulation angle between the front frame and the rear frame,
wherein the variable value of the wheelbase is a function of the articulation angle.

20. The controller of claim 16, wherein the total machine turning angle is calculated according to:
$${θ}_{M} = arc tan ( V / ( Δ {Y}_{RF} * W ) ,$$
where θ_{M} equals the total machine turning angle, V equals the machine speed, ΔY_{RF} equals the rear frame yaw rate, and W equals the wheelbase, if the first inertial motion unit is disposed on the rear frame, or
$${θ}_{M} = arc tan ( V / ( Δ {Y}_{FF} * W ) ,$$
where θ_{M} equals the total machine turning angle, V equals the machine speed, ΔY_{FF} equals the front frame yaw rate, and W equals the wheelbase, if the first inertial motion unit is disposed on the front frame.
